(19) United States
(12) Patent Application Publication
(10) Pub. No.: US 2005/0135106 A1
(43) Pub. Date: Jun. 23, 2005

(54) Fresnel lens spotlight with coupled variation of the spacing of lighting elements

(75) Inventors: Rudiger Kittelmann, Einbeck (DE); Harry Wagener, Alfeld (DE)

Correspondence Address: Charles N. J. Ruggiero, Esq.;Ohlandt, Greeley, Ruggiero & Perle, L.L.P., 10th Floor, One Landmark Square, Stamford, CT, 06901-2682, US

(73) Assignee: Schott Glas

(21) Appl. No.: 10/915,828

(22) Filed: Aug. 11, 2004

(30) Foreign Application Priority Data
Dec. 22, 2003 (DE) 103 61 122.3

(51) Int. Cl. F21V 5/00

(52) U.S. Cl. 362/326

(57) ABSTRACT

In order, in the case of a Fresnel lens spotlight with an adjustable aperture angle of the emergent light bundle and having a preferably ellipsoidal reflector, a lamp and at least one Fresnel lens, to provide a homogeneously illuminated light field in conjunction with a high efficiency, in particular including in the flood position, it is provided that the Fresnel lens has a diffusing screen.

The invention relates to a Fresnel lens spotlight with an adjustable aperture angle of the emergent light bundle, having a reflector, a lamp and at least one Fresnel lens.

In the case of conventional Fresnel lens spotlights, the part of relevance to the lighting generally comprise a lamp, a Fresnel lens and a spherical auxiliary reflector. The lamp filament is conventionally located substantially invariably at the center of the spherical reflector. Consequently, a portion of the light emitted by the lamp is retroreflected into the latter and supports the emission of light into the front half space. This light directed forwards is focused by the Fresnel lens. The degree of optical focusing is, however, a function of the spacing between the Fresnel lens and the lamp. The narrowest optical focusing occurs when the lamp filament is located at the focal point of the Fresnel lens. This results in a quasi-parallel beam path, also termed spot. By shortening the spacing between the Fresnel lens and the lamp, the aperture angle of the emergent light beam is continuously enlarged. This results in a diverging beam path, which is also termed flood. However, a disadvantage of such spotlights is the poor light yield, particularly at their spot position, since here the Fresnel lens covers only a comparatively small solid angle range of the lamp. Moreover, it is disadvantageous that a large proportion of the light reflected by the spherical reflector strikes the lamp filament itself again, is absorbed there and additionally heats up the lamp filament.

DE 39 19 643 A1 discloses a spotlight having a reflector, a diaphragm and a Fresnel lens. The illumination of the spotlight is varied by adjusting the light source. A change in brightness of the light is effected thereby. The brightness is controlled by controlling the distance between the vertex point and reflector and between the diaphragm and the reflector.

DE 34 13 310 A1 discloses a spotlight having a lamp and a reflector or a lamp and a composite lens. The spotlight further has a diffusing screen or a mirror that are both positioned at an angle of 45°. The mirror deflects the light, and the diffusing screen scatters the light. Different emission angles of the light bundle are produced by displacing the diffusing screen.

DE 101 13 385 C1 describes a Fresnel lens spotlight lens in which the Fresnel lens is a composite lens whose focal point on the light source side is located at the spot position approximately at the focal point of the ellipsoid reflector that is remote from the reflector. In this way, the lamp is not unnecessarily heated by retroreflected light. However, with increasing miniaturization of the light source, for example in the case of high-power high-pressure discharge lamps, it is possible for there to occur in the illuminated light field a middle dark area that is ever more strongly pronounced and cannot be compensated for, or can be compensated for only with large light losses, by means of diffusing devices. Even the conventional diffusing devices used to avoid imaging of the emission center of the light source provide only a partial remedy here, if at all, since at least the dark middle acceptance cone must also be homogeneously illuminated in this case in each position of the Fresnel lens spotlight. However, it is precisely thereby that large light losses come about at the spot position, in particular, since here only a dark area with a very small aperture angle is present, whereas in the case of the conventional Fresnel lenses with diffusing devices the entire area of the Fresnel lens is used nevertheless to diffuse the light field.

The aim of the invention is to provide a Fresnel lens spotlight that provides a homogeneously illuminated light field in conjunction with a high efficiency.

This object is achieved in a surprisingly simple way with the aid of a Fresnel spotlight in accordance with claim 1, and of an illumination set in accordance with claim 19.

The inventors have discovered that these high light losses can be avoided in a surprisingly simple way with the aid of a diffusing screen. It is particularly advantageous in this case if the Fresnel lens has a diffusing screen that, in a particularly preferred way, is of circular design and arranged only in the center of the Fresnel lens.

In this embodiment, the dark areas in the middle of the illumination field can be very effectively avoided in any position of the Fresnel lens spotlight, but the high light losses in the spot position of the reflector no longer occur.

It emerges in a surprising way that, in terms of geometrical optics, the beam path of the light emerging from the reflector illuminates a smaller area at the location of the Fresnel lens precisely when the required fraction of scattered light is increased.

This effect has been exploited by the inventors in order to provide by means of the invention an automatic or adaptive light mixing system that, in addition to the light imaged by geometrical optics mixes synchronously with the adjustment of the Fresnel lens spotlight only that fraction of scattered light that is required for this position.

This light mixing ratio, which can be adapted virtually optimally to the light distributions respectively required, will be denoted below for short only as the mixing ratio.

For essentially every position of the reflector, this automatic light mixing system produces the correct mixing ratio and thus always a very homogeneously illuminated light field, but without unnecessary scattering losses occurring thereby.

The selection of the diameter of the diffusing screen in relation to the remaining area of the Fresnel lens can in this case be used to define the mixing ratio of the Fresnel lens illuminated over its entire area, and the aperture angle of the scattered light can be defined by the scattering properties of the Fresnel lens.

Furthermore, the scattering action on the integrated diffusing screen itself can vary such that, for example, more strongly scattering areas are arranged in the middle of the diffusing screen, and less strongly scattering regions are arranged at the edge thereof. This has the effect of additionally further expanding a strongly focused beam bundle, and extremely wide illumination angles can then be implemented.

Alternatively, the edge of the diffusing screen can not only also be configured to end abruptly, but it can be fashioned to have a continuously decreasing scattering effect, and also to extend under or over the Fresnel lens. Further adaptations to the mixing ratios, which are a function of position, can be undertaken thereby. In the case of the preferred embodiments, the diffusing screen can be arranged both on the light entrance side and on the light exit side. Furthermore, there is the advantageous possibility of arranging diffusing screens on the light entrance side and on the light exit side. In the case of this last-named embodiment, it is also possible to use diffusing screens that scatter differently, for example spatially differently. Reference may be made to the application, filed on the same day, of the same applicant under the title of “Optische Anordnung mit Stufenlinse” [“Optical arrangement with a Fresnel lens”], the disclosure content of which is also fully incorporated in the disclosure content of the present application by reference.

At the same time, the uniformity of the illumination level in the entire light field is maintained, as illustrated by way of example in FIG. 6 both for the spot position and for the flood position.

According to the invention, an ellipsoidal reflector with a large aperture is provided. The spot position is adjusted by virtue of the fact that the lamp filament of a black body radiator, in particular a halogen lamp, or the discharge arc of a discharge lamp is located at the focal point of the ellipsoid on the reflector side, and the second focal point of the ellipsoid, remote from the reflector, is arranged approximately at the real focal point, near the reflector, of the Fresnel lens.

The light reflected by the reflector is focused virtually completely onto the focal point of the ellipsoid remote from the reflector before entering the Fresnel lens. The lamp filament, or the discharge arc, located at the focal point of the Fresnel lens on the reflector side is imaged at infinity after passing through the Fresnel lens, and its light is thereby converted into a virtually parallel beam.

Given an expedient selection of the aperture angle of the reflector and Fresnel lens, the light reflected by the reflector is virtually completely picked up by the Fresnel lens and radiated forwards as a narrow spotlight bundle.

The aperture angle of the light bundle emerging from the Fresnel lens can be virtually arbitrarily enlarged in the case of a first embodiment by suitably varying the lamp position with reference to the reflector, on the one hand, and the spacing of the Fresnel lens from the reflector, on the other hand.

It is thereby possible to retain the good properties of conventional Fresnel lens spotlights with reference to the uniformity of the illumination level, should these variations in the spacing result from an expediently selected positive coupling.

One embodiment of the invention consists in that the ellipsoidal reflector consists of a metallic or a transparent dielectric material. It is preferred to use as dielectric materials glass and polymer materials or plastics that can be coated with metal, for example aluminum.

Alternatively, or in addition, in one embodiment with a transparent dielectric material one of the two or both surfaces of the reflector is/are provided with a system of optically thin layers in order to produce a reflecting surface. The coating of the Fresnel lens advantageously comprises a dielectric interference layer system that varies the spectrum of the light passing through. It is thereby advantageously possible for visible radiation components to be reflected, and for the invisible components, in particular thermal radiation components, to be passed.

In general, both the reflector, the Fresnel lens and/or the diffusing screen can be coated on at least one side, for example they can be coated in the case of plastic with a nonscratch and/or nonreflecting layer.

A further preferred embodiment of the invention comprises a metallic coating on one or both principal surfaces of the reflector.

In a further alternative refinement, the reflector can also be a metallic reflector that can both be uncoated and be coated with dielectric or metal, in order to provide the desired spectral and corrosion properties.

A preferred embodiment of the invention comprises a Fresnel lens spotlight in the case of which the light-reflecting surface of the reflector, preferably having partial areas or facets, is patterned to scatter light, and no, or one or two surface of the Fresnel lens are structure in a light-scattering fashion. This produces a fixed fraction of the superimposition of scattered light relative to light imaged by geometrical optics, which can reduce dark rings in the light field.

The Fresnel lens is advantageously toughened, preferably thermally toughened, at its surface in order in such a way to exhibit a higher level of strength and resistance to thermal loading.

The invention provides for the use of the spotlight for architecture, medicine, film, stage, studio and photography, as well as in a pocket lamp.

In the preferred embodiments, the diffusing screen can be arranged both on the light entrance side and on the light exit side. Furthermore, there is the advantageous possibility of arranging diffusing screens on the light entrance side and on the light exit side. It is also possible in the case of the lastmentioned embodiment to use differently scattering diffusing screens, for example ones that scatter differently spatially.

The invention will be described in more detail with the aid of preferred embodiments and with reference to the attached drawings, in which:

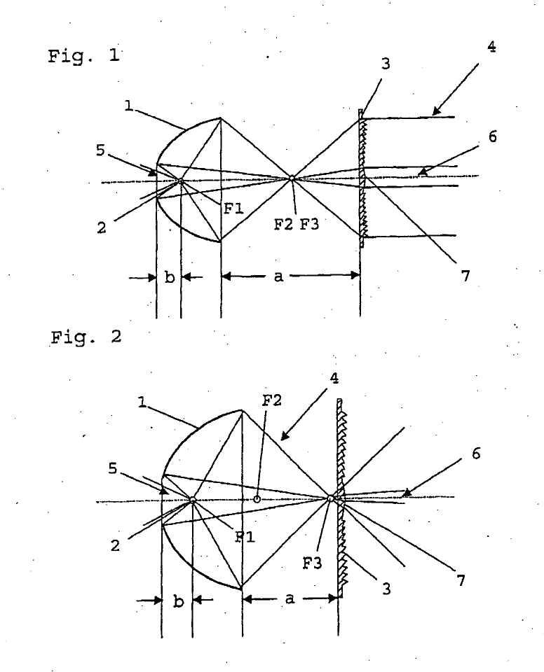

FIG. 1 shows an embodiment of the Fresnel lens spotlight in spot position, the focal point of the reflector remote from the latter being superimposed somewhat by the left-hand side, real focal point of the Fresnel lens,

FIG. 2 shows the embodiment, shown in FIG. 1, of the Fresnel lens spotlight in a first flood position, the focal point of the reflector remote from the latter being arranged near a surface of the Fresnel lens,

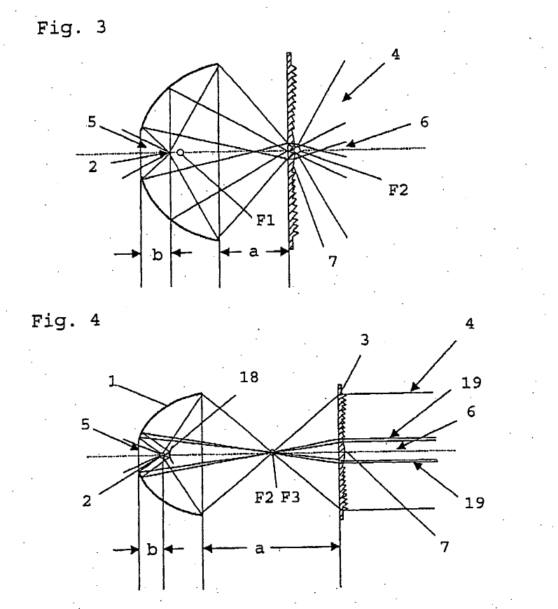

FIG. 3 shows the embodiment, shown in FIG. 1, of the Fresnel lens spotlight in a second flood position with a greater aperture angle than in the first flood position, the focal point of the reflector remote from the latter being imaged by the Fresnel lens in front of the surface of the Fresnel lens s remote from the reflector, and the light source being moved from the focal point near the reflector toward the reflector,

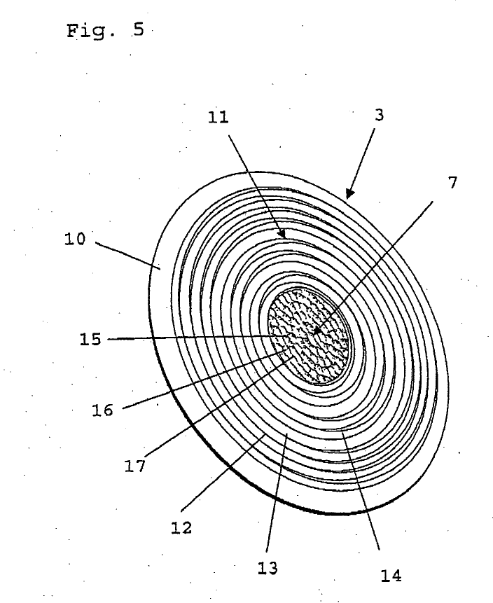

FIG. 4 shows the embodiment, illustrated in FIG. 1, of the Fresnel lens spotlight in spot position, with an additional auxiliary reflector by means of which a further portion of the light is firstly directed into the reflector and from the latter into the Fresnel lens,

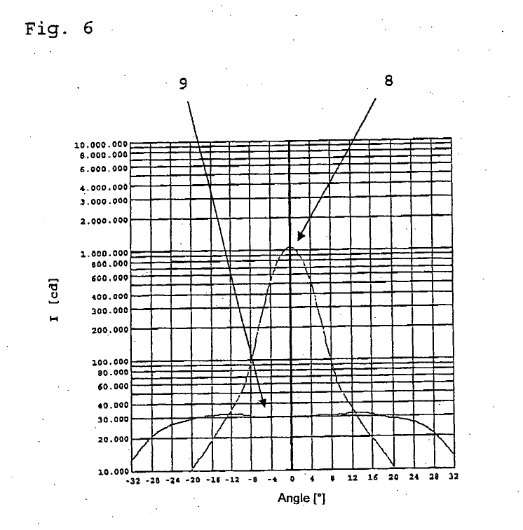

FIG. 5 shows a positive Fresnel lens with a centrally arranged diffusing screen,

FIG. 6 shows a logarithmic representation, dependent on the aperture angle, of the luminous intensity of the Fresnel lens spotlight in the latter's spot position and one of its flood positions.

### DETAILED DESCRIPTION OF PREFERRED EMBODIMENTS

It is assumed in the following detailed description that identical reference symbols denote identical or identically acting elements in the various respective embodiments.

Reference is made below to FIG. 1, which shows an embodiment of the Fresnel lens spotlight in spot position. The Fresnel lens spotlight essentially includes an ellipsoidal reflector 1, a lamp 2 that can be an incandescent lamp, particularly a halogen lamp, a light-emitting diode, a light-emitting diode array or a gas discharge lamp, and a Fresnel lens 3 that is a positive lens, preferably a planoconvex Fresnel lens.

In FIG. 1, the focal point F2 of the ellipsoidal reflector 1 remote from the reflector is superimposed somewhat by the left-hand side real or positive focal point F3 of the Fresnel lens 3.

The light bundle 4 emerging from the spotlight is indicated in the figures only schematically by the outer edge beams thereof.

The spacings a between the Fresnel lens 3 and front edge of the reflector 1, and b between the lamp 2 and vertex point of the reflector 1 are likewise illustrated in FIG. 1.

The spot position is set by virtue of the fact that the lamp filament or the discharge arc of the lamp 2 is arranged essentially at the focal point F1 of the reflector ellipsoid 1 on the reflector side.

The light reflected by the reflector 1 is directed in this position virtually completely onto the focal point F2 of the ellipsoid 1 remote from the reflector. The left-hand side positive or real focal point F3 of the Fresnel lens 3 then coincides approximately with the focal length F2 of the reflector ellipsoid.

It is also to be seen in the near field in FIG. 1 how the aperture 5 within the reflector 2 acts as a dark area 6 in the parallel beam path of the light field 4.

Provided within the Fresnel lens 3 is a circular, centrally arranged diffusing screen 7 that produces a defined scattered light ratio and a defined aperture angle of the scattered light. The result of this is to provide a defined mixing ratio of the scattered light relative to the light imaged by geometric optics by the Fresnel lens 3.

As an alternative to this embodiment of the diffusing screen 7, in a further embodiment the scattering action changes along the radius of the diffusing screen 7 steadily in such a way that more strongly scattering areas are arranged in the middle of the diffusing screen 7, and less strongly scattering areas are arranged at the abruptly ending edge thereof.

In yet a further alternative refinement, the edge of the diffusing screen 7 not only ends abruptly, but it is constructed such that its scattering action decreases steadily, and it can also extend below or above the Fresnel lens.

Further adaptations to the mixing ratios, which depend on position, are thereby taken as a function of the system such that the person skilled in the art can always provide an optimum mixing ratio for a homogeneously illuminated light field, or also for light fields with locally higher intensities produced in a defined fashion.

It may also be seen from FIG. 1 that in the spot position only a small portion of the total light passes through the diffusing screen 7.

A very homogeneous illumination results from the diffusing screen 7, as reproduced for the spot position with the line 8 in FIG. 6, which shows a logarithmic representation, dependent on aperture angle, of the light intensity of the Fresnel lens spotlight.

FIG. 2 shows the embodiment, illustrated in FIG. 1, of the Fresnel lens spotlight in a first flood position, in which the focal point F2 of the reflector 1 remote from the reflector is arranged approximately in a surface of the Fresnel lens 3 near the reflector.

The value of the displacement a relative to the spot position is in this case varied in a defined fashion by a mechanical guide.

The design corresponds in principle to the design of the Fresnel lens spotlight illustrated in FIG. 1. However, it is clearly to be seen from FIG. 2 that both the aperture angle of the emergent light bundle 4 has increased, together with the dark area 6.

However, since in this position a very high fraction of the light strikes only a very small area in the middle of the diffusing screen 7, this area especially can be configured such that the forward-scattering lobe thereof approximately compensates for the dark area 6 in the far field or far region in the desired way. Reference may also be made to FIG. 6, which reproduces the lighting conditions with the line 9, for example for a flood position.

Reference is made below to FIG. 3, which shows the embodiment, illustrated in FIG. 1, of the Fresnel lens spotlight in a second flood position with an even greater aperture angle than in FIG. 2, the focal point F2 of the reflector 1 remote from the reflector being imaged by the Fresnel lens 7 in front of the surface of the Fresnel lens 7 remote from the reflector.

In this case, a greater area of the diffusing screen 7 is transilluminated than in FIG. 2, and the entire scattering behavior thereof can be adapted to the conditions of this flood position.

As illustrated in FIG. 3, a further expansion of the beam 4 is obtained as an alternative or in addition to the flood position from FIG. 2 by changing the spacing b of the lamp 2 from the reflector 1. As the lamp 2 is displaced toward the reflector 1, the light bundle leaving the reflector is yet more strongly focused, the result being increased exit angles after the Fresnel lens 3 is exited.

In order for the uniformity of the illumination level to be maintained, in a particularly preferred embodiment the variations in spacing are performed by an expediently selected positive coupling that sets the variation of a and b to a defined ratio which is, however, not illustrated in the figures.

The variation in the spacing a and also in the spacing b can be performed by hand in one embodiment, it being possible for this purpose to use axial guidance of the optical components.

A further preferred embodiment is shown in FIG. 4. In this embodiment, which essentially corresponds, except for an additional auxiliary reflector 18, to the embodiments described above, light from the lamp 2 that would propagate to the right in FIG. 4 and no longer reach the reflector 1 is directed by the auxiliary reflector 18 into the reflector 1 by reflection. Consequently, not only is it possible to make use of the light that is illustrated only by way of example by the beam path 19 and would not contribute to the illumination without the auxiliary reflector, but it is also possible to make better use for the desired light distribution of that fraction of the light which otherwise enters the Fresnel lens 3 directly.

The shape of the auxiliary reflector 18 is advantageously selected such that light reflected thereat does not re-enter, and additionally unnecessarily heat up, the luminous means of the lamp 2, for example a filament or discharge zone.

Alternatively, the auxiliary reflector 18 can be mounted on the inside and/or outside of the glass body of the lamp 2. The glass of the lamp body can be appropriately shaped for this purpose, in order to achieve the desired directional action for the reflected light. FIG. 5 shows by way of example a Fresnel lens 3 with a diffusing screen 7, such as used by the invention. The Fresnel lens 3 has a transparent basic body 10 and a Fresnel lens ring system 11 with annular lens portions 11, 12, 13 within which the circular diffusing screen 7 is arranged.

The diffusing screen 7 is structured in a defined fashion or has facets 15, 16, 17 with a scattering behavior that can be exactly defined over large areas and are described by the title “diffusing screen” in the German patent application from the same applicant DE 103 43 630.8, which was filed on September 19 at the German Patent and Trademark Office. The disclosure content of this application is also incorporated in full in the disclosure content of this application by reference.

The invention is not, however, restricted to these previously described embodiments of diffusing screens.

The Fresnel lens spotlight described above is used with particular advantage in an illumination set together with an electric power supply unit that is substantially reduced in size by comparison to the prior art. In conjunction with a useful light power equal to that of the prior art, this power supply unit can be configured to be smaller both electrically and machanically, since the Fresnel lens spotlight according to the invention has a substantially higher light yield. A lower weight is therefore required, and less storage space is taken up during transportation and storage.

Particularly when use is made of cold light reflectors, however, this also has the result of reducing the entire thermal loading of the persons and objects being illuminated.

Furthermore, the Fresnel lens spotlight according to the invention can also advantageously be used to increase the light yield in pocket lamps.

List of Reference Numerals
1 Reflector
2 Lamp
3 Fresnel lens
4 Emergent light bundle
5 Aperture in the reflector 1
6 Dark area
7 Diffusing screen
8 Intensity distribution in spot position
9 Intensity distribution in flood position
10 Basic body
11 Fresnel lens ring system
12 Annular lens portions
13 Ditto
14 Ditto
15 Facet
16 Ditto
17 Ditto
18 Auxiliary reflector 19 Beam path reflected by auxiliary reflector

1. A Fresnel lens spotlight comprising:
an emergent light bundle having an adjustable aperture angle;
a reflector;
a lamp; and
at least one Fresnel lens, wherein the at least one Fresnel lens has a diffusing screen.

2. The Fresnel lens spotlight as claimed in claim 1, wherein the diffusing screen is of circular design and is arranged at the center of the at least one Fresnel lens.

3. The Fresnel lens spotlight as claimed in claim 1, wherein the at least one Fresnel lens defines with the diffusing screen a light mixing system that varies the fraction of the scattered light relative to the fraction of the light imaged by geometrical optics, and thereby the light mixing ratio, as a function of the position of the Fresnel lens spotlight.

4. The Fresnel lens spotlight as claimed in claim 1, wherein the at least one Fresnel lens has a real focal point on which it is possible to superimpose a focal point of the reflector that is remote from the reflector.

5. The Fresnel lens spotlight as claimed in claim 1, wherein the at least one Fresnel lens is a planoconvex positive lens designed as a Fresnel lens.

6. The Fresnel lens spotlight as claimed in claim 1, wherein the at least one Fresnel lens comprises a double lens with chromatically corrected imaging properties.

7. The Fresnel lens spotlight as claimed in claim 1, wherein the at least one Fresnel lens and the reflector define a first spacing that can be varied as a defined geometric function in relation to a second spacing defined between the lamp and the reflector in accordance with the adjustable aperture angle.

8. The Fresnel lens spotlight as claimed in claim 7, wherein the lamp is arranged with reference to a vertex point of the reflector so that the second spacing can be adjusted.

9. The Fresnel lens spotlight as claimed in claim 1, wherein the reflector comprises a material selected from the group consisting of transparent dielectric material, glass, and plastic.

10. The Fresnel lens spotlight as claimed in claim 1, wherein the reflector has two principal surfaces having a system of optically thin layers.

11. The Fresnel lens spotlight as claimed in claim 10, wherein at least one of the two principal surfaces is coated with metal.

12. The Fresnel spotlight as claimed in claim 1, wherein the reflector, has a light reflecting surface that is structured in a light-scattering fashion, and wherein the at least one Fresnel lens has a number of surfaces that are, in addition to the diffusing screen, patterned to scatter light, the number of surfaces being selected from the group consisting of zero, one, and two.

13. The Fresnel lens spotlight as claimed in claim 1, wherein at least one the Fresnel lens is a positive lens.

14. The Fresnel lens spotlight as claimed in claim 1, wherein the reflector, the at least one Fresnel lens and/or the diffusing screen are coated on at least one side.

15. The Fresnel lens spotlight as claimed in claim 1, further comprising a coating on the at least one Fresnel lens, wherein the coating comprises a dielectric interference layer system that varies the spectrum of the light passing through the at least one Fresnel lens.

16. The Fresnel lens spotlight as claimed in claim 1, wherein the lamp is selected from the group consisting of an incandescent lamp, a halogen lamp, a light-emitting diode, a light-emmitting diode array, and a gas discharge lamp.

17. The Fresnel lens spotlight as claimed in claim 1, further comprising an auxiliary reflector arranged between the at least one Fresnel lens and the reflector.

18. The Fresnel lens spotlight as claimed in claim 1, wherein the at least one Fresnel lens includes a thermally toughened surface.

19. An illumination set comprising:
a Fresnel lens spotlight having an emergent light bundle with an adjustable aperture angle, a reflector, a lamp, and a Fresnel lens with a diffusing screen; and
an assigned electrical power supply unit or ballast.

20. The illumination set as claimed in claim 19, wherein the spotlight is adapted to be used in a discipline selected from the group consisting of medicine, architecture, film, stage, studio, and photography.

21. A pocket lamp comprising:
an emergent light bundle having an adjustable aperture angle;
a reflector;
a lamp;
an electrical power supply unit or ballast; and
at least one Fresnel lens, wherein the at least one Fresnel lens has a diffusing screen.
